(19) United States
(12) Patent Application Publication
(10) Pub. No.: US 2017/0240801 A1
(43) Pub. Date: Aug. 24, 2017

(54) FRACTURING FLUIDS CONTAINING A VISCOELASTIC SURFACTANT VISCOSIFIER

(71) Applicant: HALLIBURTION ENERGY SERVICES, INC., Houston, TX (US)

(72) Inventors: Snehalata S. Agashe, Pune (IN); Prajakta R. Patil, Pune (IN); Sushant D. Wadekar, Pune (IN)

(73) Assignee: Halliburton Energy Services, Inc., Houston, TX (US)

(21) Appl. No.: 15/106,088

(22) PCT Filed: Feb. 18, 2016
(86) PCT No.: PCT/US2014/017001

§ 371 Date: Jun. 17, 2016

(51) Int. Cl. C09K 8/60; E21B 43/267; E21B 43/26; C09K 8/80; C09K 8/86

(52) U.S. Cl. CPC C09K 8/602; C09K 8/80; C09K 8/86; E21B 43/26; E21B 43/267; C09K 2208/30

(57) ABSTRACT

A fracturing fluid comprising: water; a water-soluble salt; and a viscoelastic surfactant, wherein the viscoelastic surfactant: increases the viscosity of the fracturing fluid, wherein the viscosity is increased to at least a sufficient viscosity that proppant are suspended in the fracturing fluid; and is in at least a sufficient concentration such that the viscoelastic surfactant spontaneously forms micelles. A method of fracturing a subterranean formation comprising: introducing the fracturing fluid into a well, wherein the well penetrates the subterranean formation; and creating one or more fractures within the subterranean formation with the fracturing fluid.

### TECHNICAL FIELD

Fracturing fluids are used in stimulation treatments of subterranean formations. Viscosifiers are often used in a fracturing fluid to suspend proppant in the fluid in order to place the proppant within a fracture. Viscoelastic surfactants can be used in a fracturing fluid as a viscosifier.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a graph of viscosity (cP) and temperature (° F.) versus time (min) of a fracturing fluid containing a viscoelastic surfactant viscosifier according to certain embodiments.

### DETAILED DESCRIPTION

As used herein, the words “comprise,” “have,” “include,” and all grammatical variations thereof are each intended to have an open, non-limiting meaning that does not exclude additional elements or steps.

As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A heterogeneous fluid can be: a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. Any of the phases of a heterogeneous fluid can contain dissolved materials and/or undissolved solids.

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

A well can include, without limitation, an oil, gas, or water production well, a geothermal well, or an injection well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During wellbore operations, it is common to introduce a treatment fluid into the well. Examples of common treatment fluids include, but are not limited to, drilling fluids, spacer fluids, completion fluids, work-over fluids, and stimulation fluids. As used herein, a “treatment fluid” is a fluid designed and prepared to resolve a specific condition of a well or subterranean formation, such as for stimulation, isolation, gravel packing, or control of gas or water coning. The term “treatment fluid” refers to the specific composition of the fluid as it is being introduced into a well. The word “treatment” in the term “treatment fluid” does not necessarily imply any particular action by the fluid.

Hydraulic fracturing, sometimes simply referred to as “fracturing” or “fracing,” is a common stimulation treatment. A treatment fluid adapted for this purpose is sometimes referred to as a fracturing fluid or “frac fluid.” The fracturing fluid is pumped at a sufficiently high flow rate and high pressure into the wellbore and into the subterranean formation to create a fracture in the subterranean formation. As used herein, “creating a fracture” means making a new fracture in the formation or enlarging a pre-existing fracture in the formation. The fracturing fluid may be pumped down into the wellbore at high rates and pressures, for example, at a flow rate in excess of 100 barrels per minute (3,150 U.S. gallons per minute) at a pressure in excess of 5,000 pounds per square inch (“psi”) (35 megapascals “MPa”).

A newly-created or extended fracture will tend to close together after the pumping of the fracturing fluid is stopped. To prevent the fracture from closing, a material must be placed in the fracture to keep the fracture propped open. A material used for this purpose is often referred to as a “proppant.” The proppant is in the form of solid particles, which can be suspended in the fracturing fluid, carried downhole, and deposited in the fracture as a “proppant pack.” The proppant pack props the fracture in an open condition while allowing fluid flow through the permeability of the pack.

Generally, a viscosifier is added to the fracturing fluid to increase the viscosity of the fracturing fluid. As used herein, “viscosity” is the dissipative behavior of fluid flow and includes, but is not limited to, kinematic viscosity, shear strength, yield strength, surface tension, viscoelasticity, and thixotropy. This increase in viscosity allows the proppant to remain suspended within the fluid. It is also important that viscosifiers for fracturing fluids maintain the desired viscosity even under the high flow rate and pump pressures, which can impart high shear rates to the frac fluid.

Commonly-used viscosifiers include cross-linked polymeric gelling agents. However, these cross-linked polymers, and other types of viscosifiers, can leave an undesirable residue on the walls of the wellbore or fractures. This residue can cause damage to the subterranean formation and subsequent wellbore operations, such as inhibiting or preventing production of a reservoir fluid. Therefore, there is a need for viscosifiers that can be used in fracturing fluids that will suspend proppant and not cause damage to the formation.

It has been discovered that a viscoelastic surfactant can be used in fracturing fluids as a viscosifier. The surfactant can be in at least a sufficient concentration such that the surfactant spontaneously forms micelles and entanglement of the micelles helps to viscosify the frac fluid.

A surfactant is an amphiphilic molecule comprising a hydrophobic tail group and a hydrophilic head group. The hydrophilic head can be charged. A cationic surfactant includes a positively-charged head. An anionic surfactant includes a negatively-charged head. A zwitterionic surfactant includes both a positively- and negatively-charged head. A surfactant with no charge is called a non-ionic surfactant.

If a surfactant is in a sufficient concentration in a solution, then the surfactant molecules can form micelles. A “micelle” is an aggregate of surfactant molecules dispersed in a solution. A surfactant in an oil solution can form reverse-micelles with the hydrophobic tails in contact with the hydrocarbon solvent, sequestering the hydrophilic heads in the center of the reverse-micelle. Conversely, a surfactant in an aqueous solution can form micelles with the hydrophilic heads in contact with the surrounding aqueous solvent, sequestering the hydrophobic tails in the micelle center. The surfactant must be in a sufficient concentration to form a reverse-micelle or micelle, known as the critical micelle concentration. The critical micelle concentration is the concentration of surfactant above which reverse-micelles or micelles are spontaneously formed.

Viscoelasticity is the property of materials that exhibit both viscous and elastic characteristics when undergoing deformation. Viscous materials resist shear flow and strain linearly with time when a stress is applied; whereas elastic materials strain when stretched and quickly return to their original state once the stress is removed. Viscoelastic materials have elements of both of these properties and, as such, exhibit time-dependent strain.

There are several factors that can affect the viscoelasticity of a viscoelastic surfactant (“VES”). For example, the shape of the aggregation of the micelles (whether rod-shaped or spherical-shaped) can depend on the chemical structure of the surfactant, concentration of the surfactant, the nature of counter ions present in the fluid, salt concentration, pH, solubilized components (if any), co-surfactants, and temperature. Oftentimes salts present in the frac fluid can help to stabilize the rod-shaped micelle aggregation of the surfactant.

As used herein, the viscosity of a fluid is tested according to the following laboratory procedure. The fluid is mixed by placing a known volume of a salt-water solution and a known volume of a sodium laurel sulfate (SLS) solution as a co-surfactant to a mixing container and placing the container on a mixer base. The motor of the base is then turned on and maintained at 1,200 revolutions per minute (rpm) for about 2 to 3 minutes (min). A known volume of a viscoelastic surfactant (VES) is then added to the mixing container. The motor of the base is then turned back on and maintained at 1,200 rpm for about 2 to 3 min. It is to be understood that the mixing is performed at ambient temperature and pressure (about 71° F. (22° C.) and about 1 atm (0.1 MPa)). The mixed fluid is then loaded into a high-pressure, high-temperature “HPHT” viscometer, such as a CHANDLER ENGINEERING® model 5550 HPHT viscometer, with a B5X bob, a shear rate of 81 sec ⁻¹, and a pressure of 300 psi (2.1 MPa). The temperature of the fluid is then increased to a desired temperature and the viscosity in units of centipoise “cP” and the temperature in units of ° F. are recorded.

According to an embodiment, a fracturing fluid comprises: water; a water-soluble salt; and a viscoelastic surfactant, wherein the viscoelastic surfactant: increases the viscosity of the fracturing fluid, wherein the viscosity is increased to at least a sufficient viscosity that proppant are suspended in the fracturing fluid; and is in at least a sufficient concentration such that the viscoelastic surfactant spontaneously forms micelles.

According to another embodiment, a method of fracturing a subterranean formation comprises: introducing the fracturing fluid into a well, wherein the well penetrates the subterranean formation; and creating one or more fractures within the subterranean formation with the fracturing fluid.

The discussion of preferred embodiments regarding the fracturing fluid or any ingredient in the fracturing fluid, is intended to apply to the composition embodiments and the method embodiments. Any reference to the unit “gallons” means U.S. gallons.

The fracturing fluid “frac fluid” includes water. The frac fluid can be a homogenous fluid or a heterogeneous fluid. Preferably, the water is the base fluid of the frac fluid. As used herein, a base fluid is the solvent of a homogenous fluid or the continuous phase of a heterogeneous fluid. Preferably, the frac fluid is a heterogeneous fluid, such as a slurry, containing proppant as the dispersed phase of the frac fluid. For a heterogeneous fluid, the liquid continuous phase can include dissolved materials and/or undissolved solids. The water can be freshwater.

The frac fluid also includes a water-soluble salt. The water can also be seawater, brine, or a combination thereof. Preferably, the salt is selected from the group consisting of potassium chloride, ammonium chloride, sodium chloride, calcium chloride, calcium bromide, potassium bromide, magnesium chloride, sodium bromide, magnesium bromide, and any combination thereof.

According to an embodiment, the water-soluble salt is in a concentration of at least 1% by weight of the water “bwow”. According to another embodiment, the water-soluble salt is in a concentration in the range of about 1% to about 35% bwow. More preferably, the water-soluble salt is in a concentration in the range of about 3% to about 15% bwow. Without being limited by theory, it is believed that the water-soluble salt helps the viscoelastic surfactant maintain micelle entanglement to provide the desired viscosity to the frac fluid. According to another embodiment, the water-soluble salt is in a sufficient concentration such that the fracturing fluid achieves a desired viscosity. According to yet another embodiment, the water-soluble salt is in a sufficient concentration such that the fracturing fluid maintains the desired viscosity for a desired amount of time.

The fracturing fluid also includes the viscoelastic surfactant “VES”. The VES comprises a hydrophilic head group and a hydrophobic tail group. According to an embodiment, the hydrophilic head group comprises an amide, an imide, an ether (e.g., hydroxypropyl, polyoxyethylene glycol, sorbitol, or glycerol), ester sulfonates, sulfosuccinates, amine oxides, ethoxylated amides, polyethylenoxide (e.g., lauryl alcohol ethoxylate, ethoxylated nonyl phenol, ethoxylated fatty amines) betaines, quaternary amines (e.g., trimethyltallowammonium chloride, trimethylcocoammonium chloride), a phenol, or an allyl carboxylic acid (e.g., polyacrylic acid) functional group. The VES can be a cationic surfactant.

The hydrophobic tail group can have a carbon chain length in the range of C3 to C18. The hydrophobic tail group can include at least one branch. The hydrophobic tail group can also include multiple branches. Each of the branches can include a carbon chain length from C1 to C7. Preferably, the total chain length of the hydrophobic tail group, including the main chain and all branching chains, is less than or equal to C18. Without being limited by theory, it is believed that the carbon chain length of the hydrophobic tail group and the amount of branching helps the VES maintain micelle entanglement to provide the desired viscosity to the frac fluid. According to another embodiment, the carbon chain length of the hydrophobic tail group of the VES is selected such that the fracturing fluid achieves and maintains the desired viscosity for the desired amount of time. According to yet another embodiment, the amount of branching and the carbon chain length of the hydrophobic tail group are selected such that the fracturing fluid achieves and maintains the desired viscosity for the desired amount of time.

Examples of suitable viscoelastic surfactants include, but are not limited to, N-Ethyl-N,N-Dimethyl-[(3-Oxoisooctadecyl)Amino]-1-Propanaminium Ethyl Sulfate, ester sulfonates, hydrolyzed keratin, sulfosuccinates, taurates, amine oxides, ethoxylated amides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride). A commercially-available example of a suitable viscoelastic surfactant is SCHERCOQUAT™ IAS-PG Specialty Quat, available from Lubrizol Advanced Materials, Inc. in Ohio, USA. A representative chemical structure of a suitable VES is shown below.

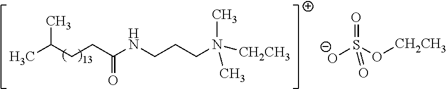

The viscoelastic surfactant is in at least a sufficient concentration such that the VES spontaneously forms micelles (i.e., the critical micelle concentration). It is believed that the carbon chain length and/or the amount of branching can also promote micelle formation. According to an embodiment, the carbon chain length of the hydrophobic tail group and/or the amount of branching, and the concentration of the VES are selected such that the VES spontaneously forms micelles. In one embodiment, the viscoelastic surfactant is in a concentration of at least 2% by volume of the fracturing fluid. In another embodiment, the viscoelastic surfactant is in a concentration in the range of about 2% to about 15% by volume of the frac fluid. In another embodiment, the viscoelastic surfactant is in a concentration in the range of about 4% to about 10% by volume of the frac fluid.

The fracturing fluid can also have a desired viscosity at a desired temperature and shear rate for a desired amount of time. The desired viscosity can be at least 300 cP, preferably from about 300 cP to about 700 cP. The desired viscosity can also be at least sufficient such that proppant is suspended in the fracturing fluid. The desired temperature can be a temperature in the range of about 70° F. to about 300F° F. (about 21° C. to about 149° C.). The desired shear rate can be 81 sec ⁻¹. According to another embodiment, the fracturing fluid has a viscosity in the range of about 300 cP to about 700 cP at the bottomhole temperature of the well and shear rate from the frac pump. The desired amount of time can be at least 2 hours. The desired amount of time can be sufficient such that the fracturing operation is completed.

According to another embodiment, the VES is in at least a sufficient concentration such that the frac fluid has a viscosity in the range of about 300 cP to about 700 cP at at least one temperature in the range of about 70° F. to about 300° F. (about 21° C. to about 149° C.) and a shear rate of 81 sec⁻¹. The carbon chain length and the amount of branching of the hydrophobic tail group can also be selected such that the frac fluid has a viscosity in the range of about 300 cP to about 700 cP at at least one temperature in the range of about 70° F. to about 300° F. (about 21° C. to about 149° C.) and a shear rate of 81 sec⁻¹. According to another embodiment, the VES is in at least a sufficient concentration such that the frac fluid has a viscosity in the range of about 300 cP to about 700 cP at the bottomhole temperature of the well and shear rate from the frac pump. The carbon chain length and the amount of branching of the hydrophobic tail group can also be selected such that the frac fluid has a viscosity in the range of about 300 cP to about 700 cP at the bottomhole temperature of the well and shear rate from the frac pump.

According to an embodiment, the VES and preferably the fracturing fluid does not leave a residue on the wall of the wellbore or fractures.

The fracturing fluid can also contain a solvent for the VES. The solvent can modify the polarity of the water-salt solution such that the VES is soluble or miscible in the frac fluid. Suitable solvents include, but are not limited to, ethylene glycol, polyethylene glycol (PEG), propylene glycol, polypropylene glycol (PPG), 2-butoxyethanol (butyl cellosolve), 2-methoxyethanol (methyl cellosolve), or combinations thereof.

The fracturing fluid can further include other additives. For example, the frac fluid can also include proppant, a co-surfactant such as sodium lauryl sulfate (SLS). The co-surfactant can provide counter ions that interact with a charged head group of the VES and can help increase the viscosity of the frac fluid.

The viscosity of a fluid can break or be reduced whereby the fluid flows easier. It may be desirable for the viscosity of a fracturing fluid to break after the fluid has been used to create the fractures in the subterranean formation. This may be desirable in order to remove or flow the frac fluid out of the well. One advantage to the present fracturing fluid is that a separate breaker system is not required to break the viscosity of the frac fluid. The viscosity of the frac fluid can break upon contact with a hydrocarbon liquid. For example, the viscosity can break when a reservoir fluid containing a liquid hydrocarbon is produced into the wellbore. The produced fluid would then come in contact with the frac fluid, thus breaking the viscosity of the frac fluid. The frac fluid can then be flowed from the subterranean formation.

The methods include introducing the fracturing fluid into a well, wherein the well penetrates the subterranean formation. The well can be an oil, gas, or water production well, a geothermal well, or an injection well. The well can include a wellbore. The subterranean formation can be part of a reservoir or adjacent to a reservoir. The step of introducing the frac fluid can be for the purpose of creating fractures within the subterranean formation. The fracturing fluid can be in a pumpable state before and during introduction into the well.

The methods also include creating one or more fractures within the subterranean formation with the fracturing fluid. The methods can further include placing proppant into the fractures. The proppant can remain in the fractures and form a proppant pack. The methods can also include introducing a consolidation fluid into the well. The consolidation fluid, for example a curable resin consolidation system, can consolidate the proppant of the proppant pack. The methods can also include causing or allowing the fracturing fluid to come in contact with a hydrocarbon liquid. According to an embodiment, the contact with the hydrocarbon liquid breaks or reduces the viscosity of the frac fluid.

### EXAMPLES

To facilitate a better understanding of the preferred embodiments, the following examples of certain aspects of the preferred embodiments are given. The following examples are not the only examples that could be given according to the preferred embodiments and are not intended to limit the scope of the invention.

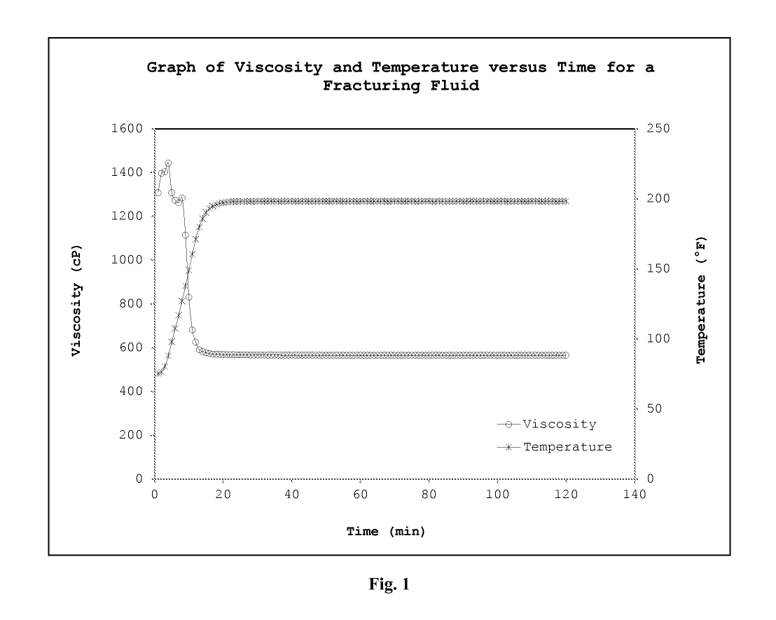

FIG. 1 is a graph of viscosity (cP) and temperature (° F.) versus time for a fracturing fluid according to certain embodiments. The fracturing fluid was mixed and tested according to the procedure for the viscosity test as described in The Detailed Description section above with a temperature of 200° F. (93° C.) and a shear rate of 81 sec⁻¹. The fracturing fluid contained the following ingredients: 500 milliliters (mL) of tap water; 30 grams (g) of potassium chloride and 15 g of ammonium chloride as the water-soluble salts; 0.085 g of a sodium lauryl sulfate solution as a co-surfactant; and 37 mL of SCHERCOQUAT™ IAS-PG Specialty Quat, which is isostearamidopropyl ethyldimonium ethosulfate as the viscoelastic surfactant and propylene glycol, available from Lubrizol Advanced Materials, Inc. in Ohio, USA. As can be seen in FIG. 1, the viscosity of the frac fluid reached approximately 600 cP at a temperature of 200° F. The viscosity was also maintained at approximately 600 cP for about 2 hours. This demonstrates that the VES functions effectively as a viscosifier in a brine fracturing fluid.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A method of fracturing a subterranean formation comprising:
introducing a fracturing fluid into a well, wherein the well penetrates the subterranean formation, and wherein the fracturing fluid comprises:
(A) water;
(B) a water-soluble salt; and
(C) a viscoelastic surfactant comprising a hydrophilic head group and a hydrophobic tail group, wherein the hydrophobic tail group has a carbon chain length in the range of C3 to C18 and branches at least once, wherein the viscoelastic surfactant:
increases the viscosity of the fracturing fluid to a viscosity in the range of about 300 cP to about 700 cP at at least one temperature in the range of about 70° F. to about 300° F. and a shear rate of 81 sec⁻¹; and
(ii) is present in the fracturing fluid in a concentration in the range of about 2% to about 15% by volume of the fracturing fluid thereby forming micelles; wherein the branches increase micelle entanglement and
creating one or more fractures within the subterranean formation with the fracturing fluid.

2. The method according to claim 1, wherein the water is freshwater, seawater, brine, or a combination thereof.

3. The method according to claim 1, wherein the water-soluble salt is selected from the group consisting of potassium chloride, ammonium chloride, sodium chloride, calcium chloride, calcium bromide, potassium bromide, magnesium chloride, sodium bromide, magnesium bromide, and any combination thereof.

4. The method according to claim 1, wherein the water-soluble salt is in a concentration in the range of about 1% to about 35% by weight of the water.

5. The method according to claim 1, wherein the water-soluble salt is in a concentration in the range of about 3% to about 15% by weight of the water.

6. The method according to claim 1, wherein the viscoelastic surfactant is a cationic surfactant.

7. (canceled)

8. (canceled)

9. The method according to claim 1, wherein the hydrophobic tail group comprises multiple branches.

10. The method according to claim 9, wherein each of the branches has a carbon chain length from C1 to C7.

11. The method according to claim 10, wherein the total chain length of the hydrophobic tail group is less than or equal to C18.

12. (canceled)

13. (canceled)

14. The method according to claim 1, wherein the viscoelastic surfactant is selected from, N-Ethyl-N,N-Dimethyl-[(3-Oxoisooctadecyl)Amino]-1-Propanaminium Ethyl Sulfate, ester sulfonates, hydrolyzed keratin, sulfosuccinates, taurates, amine oxides, ethoxylated amides, alkoxylated fatty acids, alkoxylated alcohols, ethoxylated fatty amines, ethoxylated alkyl amines, betaines, modified betaines, alkylamidobetaines, quaternary ammonium compounds, or combinations thereof.

15. (canceled)

16. (canceled)

17. (canceled)

18. (canceled)

19. The method according to claim 1, wherein the viscosity of the fracturing fluid breaks upon contact with a hydrocarbon liquid.

20. The method according to claim 1, further comprising mixing the fracturing fluid using a mixing apparatus.

21. The method according to claim 1, wherein the step of introducing comprises pumping the fracturing fluid into the well using one or more pumps.

22. A fracturing fluid comprising:
water;
a water-soluble salt; and
a viscoelastic surfactant, wherein the viscoelastic surfactant:
increases the viscosity of the fracturing fluid, wherein the viscosity is increased to at least a sufficient viscosity that proppant are suspended in the fracturing fluid; and
is in at least a sufficient concentration such that the viscoelastic surfactant spontaneously forms micelles.
